(19) United States
(12) Patent Application Publication
(10) Pub. No.: US 2012/0119882 A1
(43) Pub. Date: May 17, 2012

(54) Movement Detection Method and Reader/Writers in a Radio Frequency Identification System

(76) Inventors: Dieter Horst, Cadolzburg (DE); Dan Yu, Beijing (CN); Yong Yuan, Beijing (CN)

(21) Appl. No.: 13/386,297

(22) PCT Filed: Jul. 13, 2010
(86) PCT No.: PCT/EP2010/060048

§ 371 Date: Jan. 20, 2012

(30) Foreign Application Priority Data
Jul. 20, 2009 (CN) 200910160062.8

(51) Int. Cl. G06K 7/01

(52) U.S. Cl. 340/10.1

(57) ABSTRACT

A method in a Radio Frequency Identification (RFID) system including at least one reader/writer and a group of tags each attached to a workpiece. The method includes reading a plurality of tags from the group of tags, capturing received signal strength indication envelopes of tags, and storing the received signal strength indication envelope one tag as a template. A correlation match is performed for the received signal strength indication envelope of the tags and the template to obtain a time interval between the received signal strength indication envelope of each of the tags and the template when the correlation is at a maximum value. Using the present invention, the at least one reader/writer can report each tag that is directly in front of an antenna, even if multiple tags exist in the complicated industrial environment, ensuring First Come First-Read (FCFR) and improving the reliability of an ultra high frequency RFID system.

### CROSS-REFERENCE TO RELATED APPLICATIONS

This is a U.S. national stage of application No. PCT/EP2010/060048 filed 13 Jul. 2010. Priority is claimed on Chinese Application No. 200910160062.8 filed 20 Jul. 2009, the content of which is incorporated herein by reference in its entirety.

### BACKGROUND OF THE INVENTION

1. Field of the Invention

The present invention relates to Radio Frequency Identification (RFID) technology and, more particularly, to a tag movement detection method and corresponding reader/writers in a radio frequency identification system.

2. Description of the Related Art

With the development of science and technology, Ultra High Frequency RFID (UHF RFID) technology has an increasingly extensive use in logistics and manufacture fields. Compared with traditional High Frequency RFID (HF RFID) technology, UHF RFID technology has the advantages of faster read/write speed, lower tag cost and longer read/write range. However, due to the far field electromagnetic transmission characteristics, UHF RFID is easily influenced by multipath transmission in the complicated industrial environment, leading to a reduction in reliability, and thus limiting the application of this technology. Especially in the manufacturing field, the surrounding metals aggravate the problem associated with UHF RFIDS.

FIG. 1 is an example of identifying workpieces under the influence of multipath transmission. It can be seen from FIG. 1 that tag 1 is “in front” of tag 2 on a conveyor belt, thus tag 1 will arrive at the reader/writer earlier than tag 2. In conventional systems, when a reader/writer reads the signal of a tag for the first time, it is considered that the reader/writer starts reading the tag. However, due to the influence of multipath transmission, the reader/writer may firstly read the transmission signal of tag 2, considering tag 2 is in front of tag 1, and further send the information read from tag 2 to the sensor located ahead of it. Then, when the workpiece with tag 1 arrives at the proximity of the sensor and the operation platform, the system will mistake the tag attached to the workpiece for tag 2, leading to misoperation of the workpiece. That is, during the above tag identification process, UHF RFID technology cannot ensure the First-Come-First-Read (FCFR) principle, which will limit the application of UHF RFID technology in the product quality fields and logistics industry, such as baggage tracking at airports.

There is a general recognition of the unreliability of UHF RFID technology caused by multipath transmission. In order to make UHF RFID more practicable, most conventional solutions try to limit transmission of the electromagnetic wave. For example, in some industries where a conveyor belt is used, a special casket made of microwave absorbing material is designed to limit the transmission of the electromagnetic wave, with the goal of reducing multipath transmission and ensuring the FCFR principle. Moreover, the special casket is also employed in baggage tracking devices at airports. However, the casket is very expensive due to its use of microwave absorbing material. For example, the price of such a casket in a large size as used in airports is about 800,000 Renminbi (RMB).

### SUMMARY OF THE INVENTION

It is therefore an object of the present invention to provide a movement detection method in a radio frequency identification system and a reader/writer to realize the method, where the First-Come-First-Read (FCFR) principle towards tag reading in the radio frequency identification system can be ensured.

This and other objects and advantages are achieved in accordance with the invention by a movement detection method in a Radio Frequency Identification (RFID) system, where the RFID system includes one or more reader/writers and a group of tags, and each of the tags is attached to a workpiece, and the method includes the steps of (1) the reader/writers reading at least two tags from the group of tags, where the reading comprises capturing the received signal strength indication envelopes of said tags, and storing the received signal strength indication envelope of one of the tags as a template; and 2) performing a correlation match between the received signal strength indication envelopes of the group of tags and the template to obtain the time interval between the received signal strength indication envelopes of the group of tags and the template when the correlation value is at a maximum value.

In accordance with an embodiment of the present invention, one time in the template is taken as a standard time to obtain the time of a tag passing the reader/writers based on the standard time and the time interval.

Preferably, the standard time is the intermediate time of the template or is the time when the received signal strength indication in the template reaches the maximum value, and the time of the group of tags passing in front of the reader/writers' antenna is obtained based on the standard time and the time interval

Preferably, the tag whose received signal strength indication envelope is taken as the template is a standard tag, and this standard tag has an identifier that is different from other tags.

In accordance with another embodiment of the present invention, the group of tags for the correlation match have different identifiers.

Preferably, the group of tags for the correlation match each have an odd electronic product code identifier and an even electronic product code identifier.

Preferably, the moving speed of the workpiece is calculated according to the time interval between the group of tags for the correlation match and the distance between the group of tags.

Preferably, the moving direction of the workpiece is calculated according to the position of the tags for the correlation match.

In accordance with an embodiment of the present invention, the reader/writers read the tags located in their read/write areas during each reading cycle, capture the received signal strength indication of the tags, and then the reader/writers perform a new reading cycle for the tags located in their read/write areas.

Preferably, in each reading cycle, firstly, the reader/writers capture the received signal strength indications of each active tag located in their read/write areas, and then the reader/writers capture the received signal strength indication of a new tag that has recently entered the read/write area. Alternatively, upon continuously failing to capture the received signal strength indication of a tag, the reader/writers will identify the tag as an inactive tag.

Preferably, in each reading cycle, the reader/writers send a selection command individually to the active tags located in their read/write areas to select the tags, and capture the received signal strength indication of the selected active tags. The selection command is SELECT (MASK=Tag ID, Target=S2, Action=100), where, MASK=Tag ID indicates the selected tag identifier, Target=S2 indicates that the selected period is S2, Action=100 indicates that if the identifier of one tag matches Tag ID, S2 of the tag is set to B, else, S2 of the tag is set to A.

Preferably, in each reading cycle, the reader/writers send a query command to query the new tag that has recently entered into the read/write area, and capture the received signal strength indication of the new tag. The query command is Query (Q=0, S0, A), and for the new tag that has recently entered into the read/write area or the inactive tag, S0 of the tag is set to A, and for the active tag located in the read/write area, S0 of the tag is set to B.

Preferably, when the continuous failures to capture the received signal strength indication of a tag reach a threshold number, the tag is identified as an inactive tag.

Preferably, the reader/writers include a status table that records the received signal strength indication of each tag read by the reader/writers, the reading time, the status of the tag, and the number of the received signal strength indications of the tags, and updates the status table during each reading cycle.

Accordingly, the disclosed embodiments of the present invention provide a reader/writer that reads and writes the tags in the RFID system, where the reader/writer includes a reading unit for reading at least two tags from a group of tags and capturing the received signal strength indication envelopes of the tags, a storing unit for storing the received signal strength indication envelope of one of the tags as a template, and a correlation unit for performing a correlation match between the received signal strength indication envelopes of the tags and the template to obtain the time interval between the received signal strength indication envelopes of the tags and the template when the correlation value is a maximum value.

In a preferred embodiment, the reader/writer further includes a calculating unit, which takes a time in the template as a standard time and calculates the time of the tags passing the reader/writer based on the standard time and the time interval, or which is used to calculate the moving speed of a workpiece based on the time interval between the tags for the correlation match and the distance between the tags.

In a preferred embodiment, the reader/writer further includes a command sending unit, which is used to send the selection command and the query command, where the selection command selects the active tags located in its read/write area during each reading cycle, and captures the received signal strength indication of the selected active tags, and the query command is used to query the new tag that has recently entered into the read/write area during each reading cycle, and to capture the received signal strength indication of the new tag.

The disclosed embodiments of the present invention provide a method for detecting the moving status of an object based on the received signal strength indication (RSSI) envelope. Firstly, through this method, the reader/writer can report each tag that is directly in front of the antenna, even if multiple tags exist in the complicated industrial environment, thus ensuring the FCFR and improving the reliability of the UHF RFID system. The disclosed embodiments of the method can detect the moving speed and direction of the tags through the RSSI envelope, thereby greatly expanding the range of applications of the UHF RFID technology. Moreover, the disclosed embodiments of the method only rely on direct special signal exchange between the reader/writer and tags, and the signal design completely conforming to the current UHF RFID standard, i.e., Electronic Products Code (EPC) C1G2. Therefore, the disclosed embodiments of the method can be realized by simple modification of the reader/writer firmware, without any changes to the tags and reader/writer hardware. Furthermore, the reader/writer only relies on the relative reference value and special signal design of the RSSI envelope without any other equipment. In addition, RSSI only uses ordinary antenna without a specially designed antenna system. Moreover, the disclosed embodiments of the method rely on the relative reference value of the RSSI envelope of the moving tags in the same environment, and do not rely on any form of absolute transmission model, thus the environment and the distance between the reader/writer and tags will not have much influence on the performance.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The embodiments of the present invention are further described below in conjunction with the drawings, in which:

FIG. 1 is an exemplary schematic block diagram of identifying workpieces under the influence of multipath transmission;

FIG. 2 is a flow chart of the movement detection method in a radio identification system in accordance with an embodiment of the invention;

FIG. 3 is a schematic block diagram of a first embodiment in accordance with the present invention, i.e., a schematic block diagram of implementing the First-Come-First-Read principle by employing the RSSI envelope correlation in accordance with the present invention;

FIG. 4 is a graphical plot of the result of First-Come-First-Read detected by the prior art and the method of the present invention;

FIG. 5 is a schematic block diagram of a signaling solution which is adopted in accordance with the method of the present invention to realize the RSSI envelope correlation;

FIG. 6 is an exemplary schematic block diagram of identifying workpieces in accordance with the method of the present invention;

FIG. 7 is a schematic block diagram of a second embodiment in accordance with the present invention, i.e., a schematic block diagram for detecting the moving speed and direction of the object by employing the RSSI envelope correlation method in accordance with the present invention;

FIG. 8 is a graphical plot of the RSSI envelope correlation on two tags of one workpiece employing the RSSI envelope correlation method in accordance with the present invention; and

FIG. 9 is a graphical plot of RSSI envelope correlation on two tags of one workpiece in practical determination employing RSSI envelope correlation in accordance with the method of the present invention.

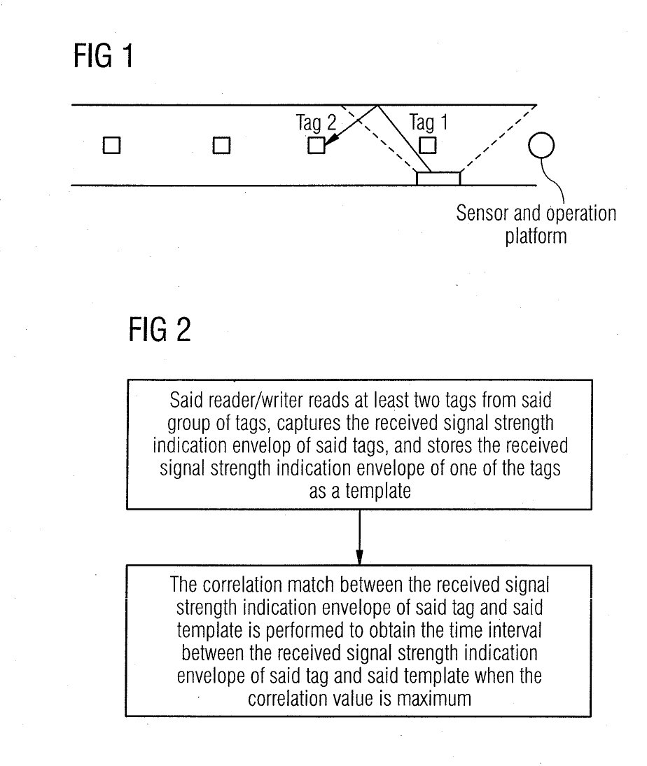

### DETAILED DESCRIPTION OF THE PREFERRED EMBODIMENTS

The core idea of the present invention is that the received signal strength indication (RSSI) of at least two tags is read to obtain the received signal strength indication (RSSI) envelope, instead of using the time when the reader/writer successfully reads a tag for the first time as the reading time of this tag. The received signal strength indication (RSSI) envelope of one of tags is used as the template, and a correlation match is performed between the received signal strength indication (RSSI) envelope of other tags and the template one by one. For any of the other tags, it can obtain the time interval between the received signal strength indication (RSSI) envelope of the tag and the template when the correlation value is at a maximum value.

The contemplated embodiments of the present invention are described in the following by the example of a radio identification system comprising reader/writers and tags.

FIG. 2 is a flow chart of a movement detection method in the radio frequency identification system of the present invention. The radio frequency identification system of the present invention includes one reader/writer with an antenna and a group of workpieces positioned on a conveyer belt, where each workpiece has at least one tag attached. There are also some tags in the read/write area of the antenna.

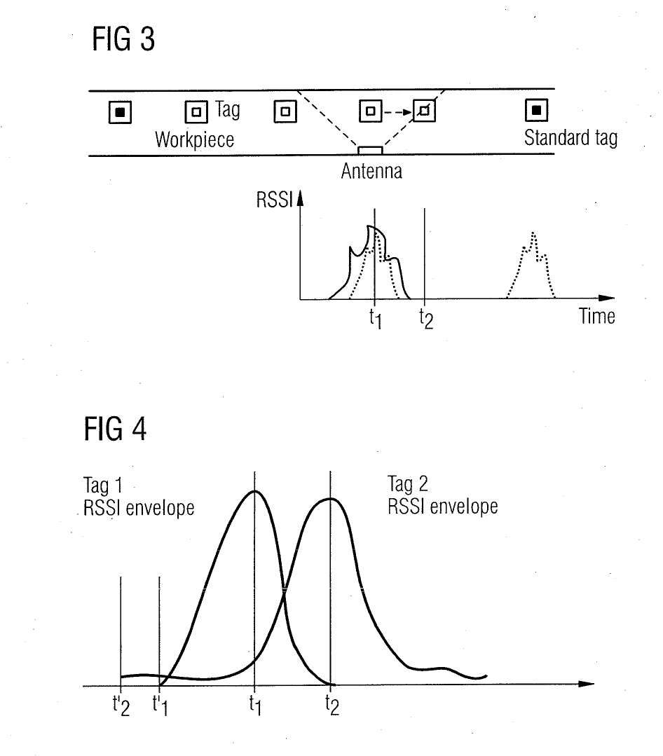

FIG. 3 is a schematic diagram of a first embodiment of the present invention. In the first Embodiment, the RSSI envelope correlation of the present invention is used to achieve the First-Come-First-Read (FCFR). Firstly, a standard tag is set on the first workpiece. The standard tag has one identifier different from those of other workpieces. The standard tag is usually set to the electronic products code (EPC) which is different from the identifiers of other tags.

Secondly, reader/writers read the standard tag, capture the received signal strength indication (RSSI) envelope of the standard tag when the tag moves in the read/write area, and store the received signal strength indication (RSSI) envelope of the standard tag as a template. The standard tag is located to the rightmost side of the upper drawing in FIG. 3. The received signal strength indication (RSSI) envelope captured and stored by the reader/writers is located to the rightmost side of the lower drawing in FIG. 3, which is stored as a template by the reader/writers.

Next reader/writers capture the received signal strength indication (RSSI) envelope of each workpiece that is moving in the read/write area. Particularly, when the reader/writer detects a workpiece tag, it immediately reports to the host. The reader/writer will further capture the identifier ID and RSSI time stamp of this workpiece until the workpiece is no longer read. The reader/writers repeat the above operations for all workpieces moving in their read/write areas.

The correlation match between the received signal strength indication (RSSI) envelope of each tag and the RSSI envelope template of the standard tag is then performed to obtain the time interval between the received signal strength indication (RSSI) envelope of the tag and the template when the correlation value is maximum. It is a proven technology in pattern recognition to match the correlation of two envelopes and identify the time interval between the received signal strength indication (RSSI) envelope of the tag and the template when the correlation value is at a maximum value.

The reader/writers can select a time in the template as a standard time. For example, the intermediate time in the template is selected as the standard time or the time when the received signal strength indication in the template reaches the maximum value is selected as the standard time. The reader/writers then obtain the time of the tag passing through the reader/writers based on the selected standard time and the time interval. When a symmetric antenna is used, the time of passing through the reader/writer described here is the time of the workpiece tag passing the front of the reader/writer's antenna. Even if an asymmetric antenna is used, any position of the antenna can be selected as the position used to define the time of passing through the reader/writer provided this position is used for all tags.

On the left of the lower drawing in FIG. 3, the dashed line is the (RSSI) envelope of the standard tag, the solid line is the (RSSI) envelope of a workpiece, and t1 is the time of the workpiece that is directly in front of the reader/writer's antenna. However, the reader/writer correlates the (RSSI) envelope of the tag only after it cannot read the tag any more, i.e., the reader/writer obtains the time t of the workpiece when it is directly in front of the reader/writer's antenna only at a later time t2 and then it informs the host that the tag was read at time t1.

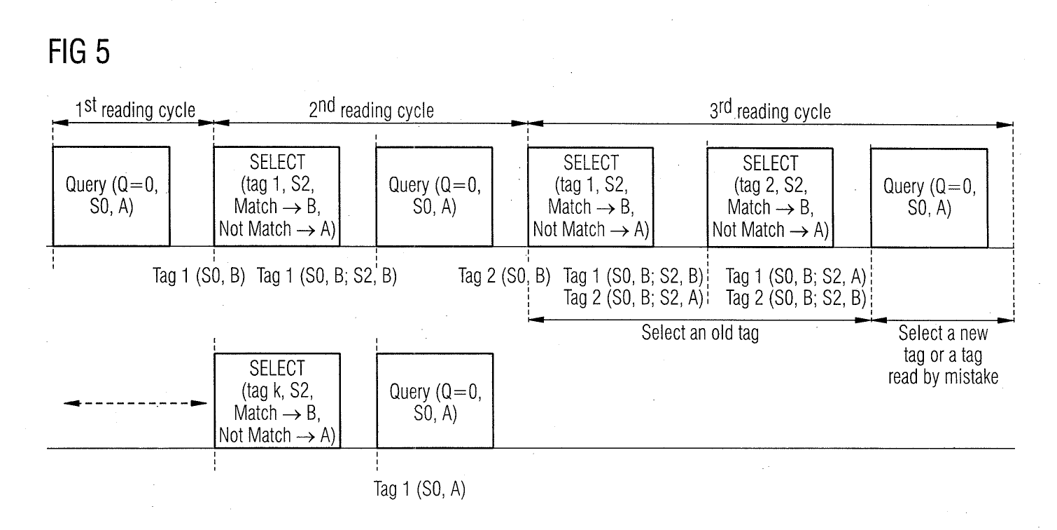

The reason for correlating the (RSSI) envelope of the workpiece with the (RSSI) envelope of the standard tag is that the two tags pass through the same environment, thus the two (RSSI) envelopes will be very similar. This is the reason why there is less impact from the environment and the distance between the reader/writer and the tag on the accuracy of the tag movement detection. The disclosed embodiment of the method can thus ensure the implementation of First-come-first-read (FCFR). The results of detecting FCFR by the prior art and the presently contemplated embodiment of the method are depicted in FIG. 4.

In accordance with the conventional tag reading method, the reader/writer immediately reports the reading of the tag once it detects the tag. In FIG. 4, although tag 2 is at the back of tag 1 on the conveyer belt, the reader/writer first reads tag 2 at t′₂ and then reads tag 1 at t′₁ due to the impact of multipath transmission. However, the reading error at time t′₂ is accidental and the reader/writer will not always have this reading error. However, even if the error happens only once, the reader/writer has violated the FCFR principle. For the method of the present invention, the reader/writer can easily judge that tag 1 is in front of tag 2 by detecting the correlation of the whole envelope of the workpiece tags and the template of the standard tag. To compensate for the environmental difference, the standard tag can also be added periodically to calibrate the RSSI template.

The following issues should be considered for better real-world application of the method provided by the present invention. Firstly, the reader/writers must have uniform, fair and quick sampling of all workpiece tags. Secondly, it is difficult to ensure that only one tag is in the reading area because of the problem of the large span of antennas, limited space between tags and multipath transmission. For this reason, the reader/writer should ensure the uniform sampling of all tags that have come into the read/write area to solve the sampling problem of multiple tags in the read/write area. Besides, the reader/writer can distinguish the tags that come into the read/write area and the mistakenly read tags that do not come into the read/write area. A special signaling transmission scheme is used in the present invention to achieve the above goal.

Firstly, for read tags, the reader/writer will create a tag status table (TST) in which all read tags are stored. For each tag, the received signal strength indication (RSSI) read at time t (time stamp), the status of the tag, and the number of times the tags are read/written are listed in Table 1. The status of tag means the following two conditions: (1) tags in the read/write area that are read by the reader/writer (hereinafter the “old tags”), or tags in the read/write area that are read by the reader/writer for the first time (hereinafter the “new tags”), and no matter whether they are old or new tags, once the tag is read by the reader/writer, its status in the reader/writer's tag status table will be set to “active tag”; and (2) tags outside the read/write area that are accidentally read by the reader/writer once or more times but are not read by the reader/writer the next few times (hereinafter the “inactive tags”).

TABLE 1
“Tag status table” stored in reader/writers

| | | | Number of |
|---|---|---|---|
| Tag ID | (RSSI, Time stamp) | Status | readings |
| Tag 1 | (RSSI1, t1), (RSSI2, | Active Tag | N1 |
| | t2) . . . | | |
| Tag 2 | (RSSI1, t1), (RSSI2, | Active Tag | N2 |
| | t2) . . . | | |

When reading the tag, the reader/writer reads the tag for N reading cycles. Here, each reading cycle is divided into two parts. In the first part, the reader/writer first processes the tags with “active tag” status in the tag status table. In the second part, the reader/writer processes the new tag that has recently entered into the read/write area, or inactive tag.

In any reading cycle, once the reader/writer detects a tag, it immediately adds the tag to the tag status table TST or updates the data in the tag status table TST. Furthermore, the tags read by the reader/writers are divided into two types. One type is the tag newly detected by the reader/writer and the tag will be added by the reader/writer to the tag status table TST, and the status of the tag will be set to “active tag” in the tag status table TST, and the number of readings will be set to 1. The other type is the re-read tag which has been read before. Here, the status of the tag is also set to “active tag” in the tag status table TST, and the reader/writer updates the number of readings for the tag in the tag status table. In addition to the above two cases, if the reader/writer reads a tag for one or more times in succession in the previous few reading cycles but does not read the tag in the next few reading cycles, the status of the tag is updated to “inactive tag” in the tag status table TST.

In the first part of each reading cycle, the reader/writer sends a selection command SELECT for each active tag in the tag status table TST. In the SELECT command, the parameters are as follows: MASK=Tag ID, Target=S2, Action=100. The operation corresponding to Action=100 is that S2 of the matching tag is set to B if the TagID of the tag matches the TagID in the SELECT command and that S2 is set to A if they do not match. In the first part of each reading cycle, through the SELECT command, the reader/writer can select the active tags in the tag status table TST one by one, read the RSSI and record the reading time for the selected tag, and add the RSSI result and reading time to the tag status table TST. Through this selection command, it is ensured that all active tags in the tag status table can be sampled once in the first part of each reading cycle, thus ensuring uniform sampling of the tags present in the read/write area.

In the second part of each reading cycle, the reader/writer queries the new tag that recently entered into the reading area. The reader/writer sends a query command Query (Q=0, S0, A). The reason for adopting the query command Query (Q=0, S0, A) is described below. For a new tag that has just entered into the read/write area, its S0 is set to A. For active tags present in the read/write area that are read once by the reader/writers, S0 is set to B. For tags that were read once by the reader/writers and as such their S0 have been set to B, if the inactive tags are not read by the reader/writers in the next reading cycle, their S0 will be set to A. In other words, the active tags with S0 set to B would not respond to the command Query (Q=0, S0, A) in the second part of the reading cycle. Only new tags or inactive tags will have their S0 set to A. After the Query command in the second part of cycle, the reader/writer also adds new tags or inactive tags to the tag status table TST and sets their status as “active tag” and “inactive tag”, respectively.

Furthermore, for the abovementioned inactive tags, a decision threshold is usually set. That is, if the reader/writer first reads an inactive tag and does not read the tag in the next cycles (threshold), the tag is considered an inactive tag.

FIG. 5 gives the special signaling transmission scheme diagram to implement RSSI correlation matching in accordance with the present invention. In the first cycle shown in FIG. 5, there is no active tag read from the read/write area because reader/writers just start the reading process. Thus, the reader/writer sends a query command Query (Q=0, S0, A). Tag 1 is a new tag and its S0 is A. The reader/writer reads a received signal strength indication (RSSI) of tag 1, records the reading time, and adds the above information about tag 1 to the tag status table TST. After reading tag 1, the status of tag 1 in the tag status table TST is “active tag”, the number of read/write is 1, and S0 of tag 1 is set to B.

In the second reading cycle, the reader/writer first sends a selection command SELECT in the first part of the cycle to select the active tag with the parameters of SELECT (MASK=Tag 1, Target=S2, Action=100). That is, if tag 1 finds that the MASK in the SELECT command is tag 1, then S2 of tag 1 is set to B, that is, the reader/writer selects tag 1 by the SELECT command, and reads one received signal strength indication (RSSI) of tag 1 and records the time of reading, and adds the above information about tag 1 to the tag status table TST. After tag 1 is read, the status of tag 1 in the tag status table TST is “active tag”, the number of read/write repetitions is 2, and S0 of tag 1 is B.

The reader/writer then sends a query command Query (Q=0, S0, A) in the second part. Since S0 of tag 1 is B, it does not respond to the command. Tag 2 is a new tag and its S0 is A. The reader/writer reads a received signal strength indication (RSSI) of the new tag 2, records the reading time, and adds the above information about tag 2 to the tag status table TST. After reading tag 2, the status of tag 2 in the tag status table TST is set to active, the number of read/write repetitions is 1, and S0 of tag 2 is set to B.

In the third reading cycle, the reader/writer sends a selection command SELECT in the first part and reads the active tag. The specific parameter is SELECT (MASK=Tag 1, Target=S2, Action=100). At this time, tag 1 and tag 2 are in the read/write area. If tag 1 finds that MASK in SELECT command is tag 1, then S2 of tag 1 is set to B. If tag 2 finds that MASK in the SELECT command is tag 1 rather than tag 2, then S2 of tag 2 is set to A. That is, the reader/writer selects tag 1 through the SELECT command, reads a received signal strength indication RSSI of tag 1, records the reading time for tag 1, and adds the above information about tag 1 to the tag status table TST. After tag 1 is read, the status of tag 1 in the tag status table TST is “active tag”, the number of read/write repetitions is 3, and S0 of tag 1 is B. At the same time, the status of tag 2 in the tag status table TST is set to active, the number of read/write repetitions is 1, and S0 of tag 2 is set to B.

The reader/writer then resends a selection command SELECT to read the active tag with parameter SELECT (MASK=Tag 2, Target=S2, Action =100). In other words, if tag 2 finds that MASK in the SELECT command is tag 2, then S2 of tag 2 is set to B. If tag 1 finds that MASK in the SELECT command is tag 2 rather than tag 1, then S2 of tag 1 is set to A. That is, the reader/writer selects tag 2 through the SELECT command, reads a received signal strength indication RSSI of tag 2, records the time, and adds the above information about tag 2 into the tag status table TST. After reading tag 2, the status of tag 2 in the tag status table TST is active, the number of read/write repetitions is 2, and S0 of tag 2 is B. At the same time, the status of tag 1 in the tag status table TST is active, the number of read/write repetitions is 3, and S0 of tag 2 is set to B.

The reader/writer then sends a query command Query (Q=0, S0, A) in the second part of the cycle. Since both tag 1 and tag 2 have S0 set to B, they do not respond to the command. The reader/writer reads the new tags with an S0 of A, or inactive tags.

In the fourth reading cycle, the reader/writer first sends a selection command SELECT in the first part of the cycle and reads the active tags. Assuming that tag 1 is the tag that is outside the read/write area and is accidentally read by the reader/writer, if tag 1 is read by the reader/writer in the previous three reading cycles and is not read by the reader/writer in the fourth reading cycle, then tag 1 automatically sets its S0 to A when the fourth reading cycle ends. In other words, for a tag with S0 as B that is read by the reader/writer once or several times in succession, if it is not read once, its S0 would be set back to A and the status of tag 1 in the tag status table is set to inactive by the reader/writer.

If tag 1 is not read in the next several reading cycles, where the particular number of reading cycles can be limited by the threshold, it can be decided that tag 1 is a tag that is read by mistake. Furthermore, the active tag can be set to inactive tag by reading the received signal strength indication (RSSI) value. For example, when the received signal strength indication (RSSI) value is very small, the tag is considered a tag that is read by mistake, and its S0 will be set to A, and its status will be set to inactive. Only when tag 1 truly moves into the read/write area of the reader/writer can the reader/writer continuously read tag 1.

If a tag in the read/write status table is continuously read for many times and that tag is not read for a period of time later on, it can be decided that the tag has left the read/write area. Thus, the correlation match can be implemented by using a series of received signal strength indications (RSSI) and the corresponding time stamp and the template.

It is illustrated in FIG. 5 that the reading cycle of the presently disclosed embodiments of the invention can ensure uniform sampling and recording of the received signal strength indication (RSSI) envelope of each tag. The time of each tag located directly in front of the reader/writer's antenna can be obtained by performing a correlation match between the (RSSI) envelope of each tag and the (RSSI) envelope of the standard tag.

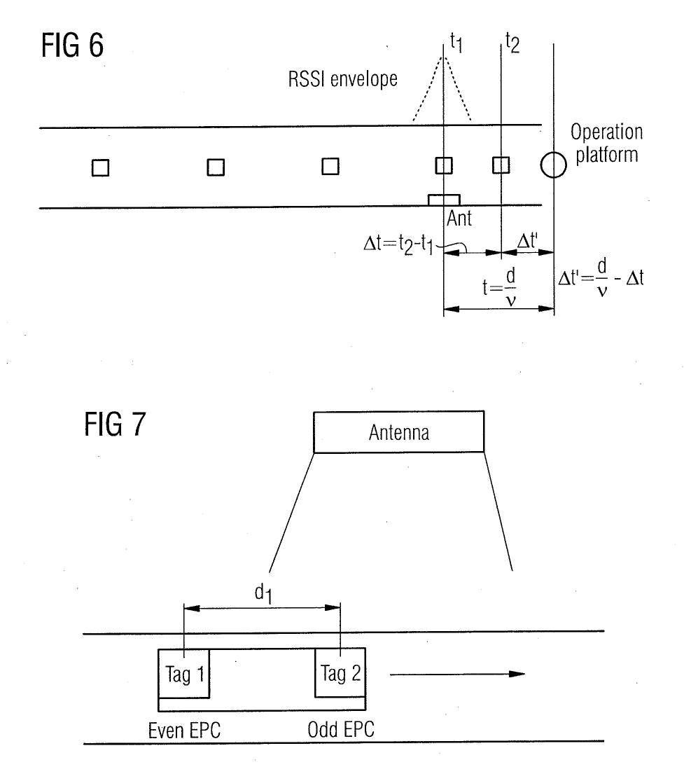

FIG. 6 is an exemplary schematic block diagram of the present invention used for identifying workpieces. The antenna is placed at a location not far from the operation platform. The distance between the antenna and the operation platform is known and is expressed as d. At time t₂, the reader/writer can determine that the tag is directly in front of the antenna at time t₁. The reader/writer can estimate how long the tag would arrive at the operation platform from the time t₂ by the equation d/v−(t₂−t₁). Then, when the tag arrives at the operation platform, the system determines the right tag ID according to the proximity senor of the operation platform, thus ensuring the (FCFR) is achieved.

FIG. 7 is a schematic block diagram of a second embodiment of the present invention, i.e., a schematic block diagram of the application of RSSI envelope correlation in accordance with the disclosed embodiments of the present invention for detecting the moving speed and direction of an object. The radio frequency identification system in FIG. 7 includes one reader/writer and a group of workpieces, where two tags, i.e., the first tag and the second tag, are attached to the two ends of one workpiece.

Firstly, the TagIDs of the first tag and the second tag are set differently. For example, the identifier of the first tag is set to an odd EPC identifier and the identifier of the second tag is set to an even EPC identifier.

The reader/writer then separately reads the first tag and the second tag and captures the RSSI envelopes of the first tag and the second tag moving in the read/write area. When the tags move rightward as shown in FIG. 7 by the arrow, the reader/writer first reads the RSSI envelope of the first tag and stores the RSSI envelope of the first tag as a template. Then, the reader/writer reads the received signal strength indication (RSSI) envelope of the second tag.

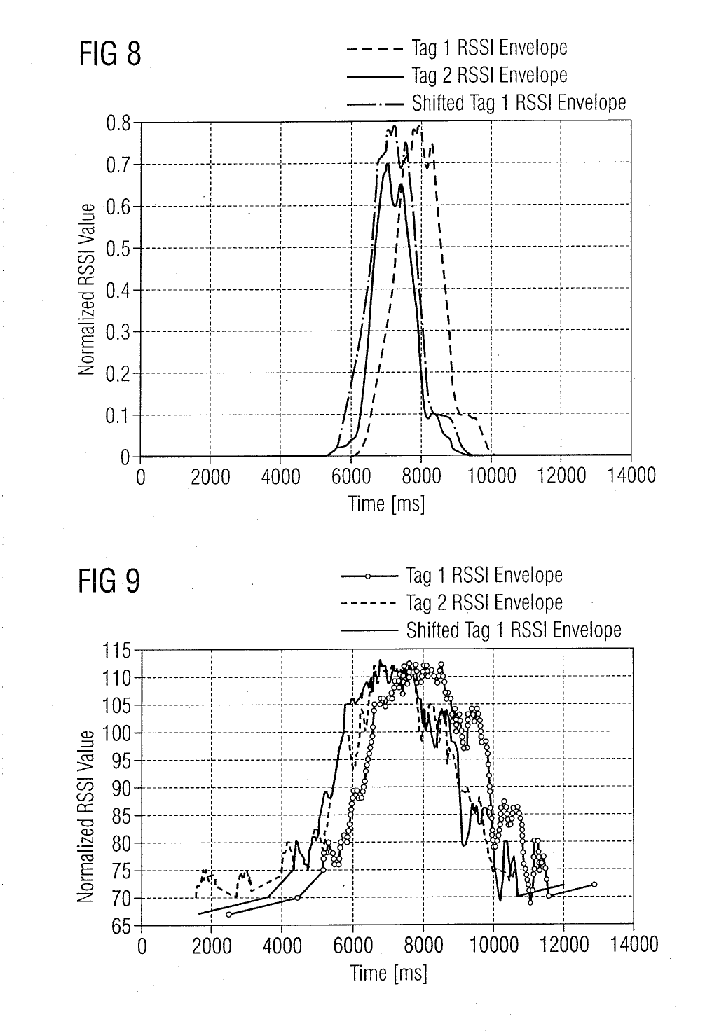

Next the reader/writer performs the correlation match between the RSSI envelope of the second tag and the RSSI envelope template of the first tag to obtain the time interval Δt between the RSSI envelopes of the two tags when the RSSI envelope correlation value of the two tags is a maximum value. FIG. 8 shows a graphical plot of the RSSI envelope correlation of two tags on a workpiece using the RSSI envelope correlation match in accordance with the disclosed embodiments of the method of the present invention. The obtained time interval in the figure is T_{d}.

Then, according to the time interval Δt between the two tags and the distance d between the two tags, the moving speed of the workpiece is calculated, i.e., v=d/Δt. In addition, according to the position of the two tags for the correlation match, the moving direction of the workpiece can be obtained. For example, if the rightward moving time is used as the time axis, the tag with the odd EPC identifier in FIG. 7 is ahead of the tag with the even EPC identifier. Thus it is decided that the workpiece moves rightward.

As a variant of embodiment 2 of the present invention, three tags can be individually attached to the two ends and the middle of the workpiece. For example, the tags are the first tag, the second tag and the third tag from left to right. For any two tags, the method in the above-described second embodiment can be used to detect the moving speed of the object. The average speed of the workpiece can then be calculated based on the obtained moving speeds of the three tags or two thereof.

In the above-described second embodiment, the signaling transmission scheme that is used is completely the same as that in the first embodiment so it is not repeated herein.

FIG. 9 shows a graphical plot of an actually measured RSSI envelope correlation of two tags on a workpiece using the RSSI envelope correlation match method in accordance with disclosed embodiments the present invention. It can be seen in FIG. 9 that the disclosed embodiments of the method of the present invention can find the correct time point of the RSSI envelope correlation, thereby detecting the moving direction/speed.

It is also an object of the present invention to provide a reader/writer in an RFID system for reading and writing tags, here the reader/writer includes a reading unit for reading at least two tags in a group of tags, and capturing the RSSI envelope of said tag; a storing unit for storing the RSSI envelope of one tag as a template; and a correlation unit for performing the correlation match between the RSSI envelope of the tag and the template to obtain the time interval between the RSSI envelope of the tag and the template when the correlation value is at the maximum value.

The reader/writer further includes a calculating unit for setting a time in the template as a standard time and calculating the time of the tag passing the reader/writer based on said standard time and said time interval or for calculating the moving speed of the workpiece based on the distance between the tags and the time interval between the tags for the correlation match.

The reader/writer further includes a command sending unit for sending the selection command and the query command, where the selection command selects active tags located in the read/write area during said each reading cycle and captures the received signal strength indication of said selected active tag, where the query command queries a new tag that has recently entered into the read/write area during each reading cycle, and captures the received signal strength indication of the new tag.

These are only the preferred embodiments of the present invention and it should be noted that for those skilled in the art, improvements and modifications can be made without departing from the principle of the present invention and these improvements and modifications should also fall within the protective scope of the present invention.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-19. (canceled)

20. A movement detection method in a Radio Frequency Identification (RFID) system including at least one reader/writer and a group of tags, each of said tags in the group of tags being attached to a workpiece, the method comprising:
reading, by said at least one reader/writer, a plurality of tags from said group of tags to capture received signal strength indication envelopes each of said plurality of tags and to store the received signal strength indication envelope of one tag of the plurality of tags as a template; and
performing a correlation match between the received signal strength indication envelopes of each of said plurality of tags and said template to obtain a time interval between the received signal strength indication envelopes of each of said plurality of tags and said template when the correlation is at a maximum value.

21. The movement detection method in the RFID system as claimed in claim 20, wherein a time in said template is set as a standard time to obtain the time of each of said plurality of tags passing the at least one reader/writer based on the standard time and the time interval.

22. The movement detection method in the RFID system as claimed in claim 21, wherein the standard time is at least one of an intermediate time of the template and a time when the received signal strength indication in the template reaches the maximum value, and the time of each of said plurality of tags passing in front of an antenna of the at least one reader/writers is obtained based on the standard time and the time interval.

23. The movement detection method in the RFID system as claimed in claim 21, wherein the one tag of the plurality of tags whose received signal strength indication envelope is set as the template is a standard tag having an identifier which is different from other tags.

24. The movement detection method in the RFID system as claimed in claim 20, wherein each tag of the plurality of tags for the correlation match has a different identifier.

25. The movement detection method in the RFID system as claimed in claim 24, wherein each tag of the plurality of tags for the correlation match has an odd electronic product code identifier and an even electronic product code identifier.

26. The movement detection method in the RFID system as claimed in claim 24, wherein a speed of movement of said workpiece is calculated according to the time interval between each of said plurality of tags for the correlation match and a distance between each of said plurality of tags.

27. The movement detection method in the RFID system as claimed in claim 25, wherein a speed of movement of said workpiece is calculated according to the time interval between each of said plurality of tags for the correlation match and a distance between each of said plurality of tags.

28. The movement detection method in the RFID system as claimed in claim 24, wherein a direction of movement of the workpiece is calculated according to a position of each of said plurality of tags for the correlation match.

29. The movement detection method in the RFID system as claimed in claim 20, further comprising:
reading, by the at least one reader/writer, each of the plurality of tags located in a read/write area of the at least one reader/writer during each reading cycle;
capturing, by the at least one reader/writer, the received signal strength indication envelope of each of said plurality of tags; and
performing, by the at least one reader/writer, a new reading cycle for each of the plurality of tags located in the read/write area of the at least one reader/writer.

30. The movement detection method in the RFID system as claimed in claim 29, further comprising:
capturing, by said at least one reader/writer, the received signal strength indication of each active tag located in their read/write areas during each reading cycle; and
capturing, by the at least one reader/writer, the received signal strength indication of a new tag which has just come into the read/write area, or continuously failing to capture the received signal strength indication of a tag, they will identify said tag as an inactive tag.

31. The movement detection method in the RFID system as claimed in claim 30, further comprising:
sending, by the at least one reader/writer, a selection command individually to active tags of the plurality of tags located in a read/write area of the at least one reader/writer during each reading cycle to select each of said active tags; and
capturing, by the at least one reader/writer, the received signal strength indication of each of said selected active tags.

32. The movement detection method in the RFID system as claimed in claim 31, wherein the selection command is SELECT (MASK=Tag ID, Target=S2, Action=100), wherein, MASK=Tag ID indicates a selected tag identifier, Target=S2 indicates that a selected period is S2, and Action=100 indicates that if the identifier of one tag matches Tag ID, then S2 of the tag is set to B, else, S2 of the tag is set to A.

33. The movement detection method in the RFID system as claimed in claim 30, further comprising:
sending, by the at least one reader/writer, a query command to query a new tag which has just come into the read/write area in said each reading cycle, said reader/writers send; and
capturing the received signal strength indication envelope of said new tag.

34. The movement detection method in the RFID system as claimed in claim 33, wherein the query command is Query (Q=0, S0, A), and for the new tag which has recently entered into the read/write area or for the inactive tag, S0 of the tag is set to A, and for the active tag located in said read/write area, S0 of the tag is set to B.

35. The movement detection method in the RFID system as claimed in claim 30, wherein, when continuous failures to capture the received signal strength indication envelope of a tag reach a threshold number, the tag is identified as an inactive tag.

36. The movement detection method in the RFID system as claimed in claim 29, wherein the at least one reader/writer includes a status table which records the received signal strength indication envelope of each tag of the plurality of tags read by said at least one reader/writer, a reading time, a status of said plurality of tags, and a number of the received signal strength indication envelop of each of the plurality of tags, and updates the status table during each reading cycle.

37. A reader/writer configured to read and writes tags in a Radio Frequency Identification (RFID) system, comprising:
a reading unit for reading a plurality of tags from a group of tags and capturing the received signal strength indication envelopes of each of said plurality of tags;
a storing unit for storing the received signal strength indication envelope of one of the read tags of the plurality of tags as a template; and
a correlation unit for performing a correlation match between the received signal strength indication envelopes of each of said plurality of tags and said template to obtain a time interval between the received signal strength indication envelopes of each of plurality of tags and the template when the correlation is a maximum value.

38. The reader/writer as claimed in claim 37, further comprising:
a calculating unit configured to at least one of set a time in the template as a standard time and calculate a time of each of said plurality of tags passing the reader/writer based on the standard time and the time interval and calculate a speed of movement of a workpiece based on the time interval between each of the plurality of tags for the correlation match and the distance between each of said plurality of tags of the group of tags.

39. The reader/writer as claimed in claim 37, further comprising:
a command sending unit configured to send a, selection command and a query command, the selection command selecting active tags of the plurality of tags located in a read/write area of the reader/writer during each reading cycle, and captures the received signal strength indication envelope of the selected active tags, and the query command querying a new tag which has recently entered into the read/write of the reader/writer during each reading cycle, and the command sending unit being further configured to capture the received signal strength indication envelope of the new tag.

40. The reader/writer as claimed in claim 37, further comprising:
a command sending unit configured to send a selection command and a query command, the selection command selecting active tags of the plurality of tags located in a read/write area of the reader/writer during each reading cycle, and captures the received signal strength indication envelope of the selected active tags, and the query command querying a new tag which has recently entered into the read/write of the reader/writer during each reading cycle, and the command sending unit being further configured to capture the received signal strength indication envelope of the new tag.
